(19) United States
(12) Patent Application Publication
(10) Pub. No.: US 2025/0276324 A1
(43) Pub. Date: Sep. 4, 2025

(54) Strand Pelletizer

(71) Applicant: Maag Germany GmbH, Grossostheim (DE)

(72) Inventors: Stefan Dahlheimer, Kleinostheim (DE); Stephan Staab, Westerngrund (DE); Matthias Namyslo, Aschaffenburg (DE)

(21) Appl. No.: 18/985,753

(22) Filed: Dec. 18, 2024

(30) Foreign Application Priority Data
Feb. 29, 2024 (DE) 10 2024 105 732.7

(51) Int. Cl. B02C 18/18; B02C 18/14; B02C 25/00

(52) U.S. Cl. CPC B02C 18/186; B02C 18/148; B02C 25/00

(57) ABSTRACT

A strand pelletizer for pelletizing strands such as strands of plastic material into pellets, having a cutting mechanism which has a rotationally drivable cutting rotor and a counter-knife cooperating therewith, wherein a cutting gap is formed between a cutting edge of the counter-knife and rotor tooth tips of the cutting rotor. A cutting gap adjustment apparatus with a cutting gap adjustment drive is provided for adjusting the gap dimension of the cutting gap during operation of the cutting mechanism.

### CROSS-REFERENCE TO RELATED APPLICATIONS

This application claims benefit under 35 USC § 119 of DE Application No. 10 2024 105 732.7 filed 29 Feb. 2024, which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention generally relates to pelletizing, and more particularly to a cutting mechanism for a pelletizer, and a strand pelletizer for pelletizing strands such as strands of plastic material into pellets with the cutting mechanism.

### 2. Description of Related Art

Conventional strand pelletizers are usually used for pelletizing strands of plastic material, which are produced by means of a caster and a corresponding nozzle plate and fed to the strand pelletizer via a drainage trough, cf. for example DE 31 45 613 A1, EP 0 079 609 A1 or U.S. Pat. No. 4,528,157 B1. However, other materials such as foodstuffs in the form of pasta strands or pharmaceutically active material strands can also be granulated into tablets using such strand pelletizers, which can perform a dry cut. By feeding several strands side by side in parallel to the cutting mechanism, there can be achieved high throughput rates.

The cutting mechanism comprises a rotationally drivable cutting rotor, which can have rib-shaped or strip-shaped cutting projections or rotor teeth on its circumferential surface, which interact with a stationary counter-knife. The counter-knife can substantially consist of a cutting strip that is positioned adjacent to the circumference of the cutting rotor so that the passing, strip-shaped projections or rotor teeth of the cutting rotor can cut the strands of plastic material on the counter-knife.

In order to be able to feed the strands in a controlled alignment and speed to the working area of the cutting mechanism, i.e., the area between the counter-knife and the cutting rotor, a feed device is connected upstream of the cutting mechanism, which has feed rollers rotating in opposite directions, between which the strands are conveyed in order to be fed onto the cutting mechanism.

Such cutting mechanisms having a pair of feed rollers are known, for example, from the DE 101 06 677 C1, DE 34 26 316 A1, DE 31 45 613 A1 and DE 26 00 078 A1.

In order to achieve a high-quality cut of the strands of plastic material and to make the cutting process efficient, the cutting gap between the rotor teeth of the cutting rotor and the cutting edge of the counter-knife must be very small and very precisely adjusted, whereby the cutting gap should also be as large or small as possible over the length of the cutting rotor and counter-knife. If the cutting gap is too large, the often viscoplastic or sticky strands are not sheared cleanly and do not have clean cutting edges. In addition, the load on the cutting mechanism increases significantly, as strand material can be sheared between the rotor tooth tips and the cutting edge of the counter-knife, which can lead to increased bearing loads, vibrations and an increased power requirement.

Conversely, if the cutting gap is set too small, there is a risk of direct mechanical contact between the rotor tooth tips and the counter-knife if, for example, the originally very small cutting gap is further reduced due to thermal loads and the resulting deformations.

As the cutting gap should be very small, but not too small, the adjustment of the cutting gap on strand pelletizers is very difficult and cannot be done perfectly even with a lot of experience, as the influences on the cutting gap that occur during operation, such as thermal expansion processes and different strand materials, are difficult to estimate, especially during the start-up process of the strand pelletizer.

The cutting gap on strand pelletizers is usually measured manually with the machine stationary using so-called spy plates, which are available in very fine gradations, for example in thicknesses of one hundredth of a mm, so that the cutting gap between the cutting rotor and counter-knife can be precisely adjusted in the 1/100 mm range.

Nevertheless, it is difficult to set the cutting gap correctly due to the dynamic changes during the approach process. Due to the influence of the hot strands and/or the process water temperature used in each case, the cutting gap changes when the machine starts up, with a corresponding negative effect on the cutting process. Depending on the process, the gap can become larger or smaller, for example when using cold or hot process water, whereby this process is dynamic. The change occurs until a steady state is reached, whereby in extreme cases the cutting rotor can start up on the counter-knife and cause corresponding damage.

If the cutting gap increases during the start-up process, it may not be possible to set the cutting gap optimally, as it may not be possible to set the cutting gap small enough at the start of the start-up process to reliably prevent the cutting rotor from hitting the counter-knife on the one hand and to take into account the increase in the gap that occurs during the start-up process on the other.

In order to get a grip on these dynamic changes, attempts are made to carry out cutting gap measurements at short intervals in order to recognize what happens to the cutting gap under the given process conditions. However, this is both time-consuming and relatively inaccurate, as the machine cools down very quickly after being switched off and the temperatures change again, so that measurements have to be taken very quickly. In fact, as soon as the machine is stopped and the cutting head is opened, the gap changes again.

Therefore, the object of the present invention is to provide an improved strand pelletizer of the type mentioned, which avoids disadvantages of the prior art and advantageously improves the latter. In particular, an improved adjustment of the cutting gap is to be achieved, which can better take into account dynamic changes due to temperature changes, for example.

### BRIEF SUMMARY OF THE INVENTION

In an exemplary embodiment of the present invention, a cutting mechanism comprising: a rotationally drivable cutting rotor with rotor tooth tips; a counter-knife with a cutting edge; and a cutting gap adjustment apparatus; wherein: strands entering the cutting mechanism can be sheared off by the rotationally drivable cutting rotor at the counter-knife; a cutting gap is formed between the cutting edge of the counter-knife and the rotor tooth tips of the cutting rotor; and the cutting gap adjustment apparatus is configured to adjust the gap dimension of the cutting gap during operation of the cutting mechanism.

The cutting gap adjustment apparatus can comprise a cutting gap adjustment drive; a sensor system; and a control device, wherein the sensor system configured to detect one or more machine operating and/or pellet parameters during operation of the cutting mechanism; and wherein the control device configured to control the cutting gap adjustment drive depending on one or more of the machine operating and/or pellet parameters detected by sensor system.

The control device of the cutting gap adjustment apparatus can be further configured to automatically actuate the cutting gap adjustment drive during operation of the cutting mechanism without the intervention of a machine operator.

The cutting gap adjustment apparatus can comprise a feed device for adjusting the rotationally drivable cutting rotor towards and away from the counter-knife.

The counter-knife can be fixably mounted.

In another exemplary embodiment, the present invention is a strand pelletizer with the innovative a cutting mechanism. The strand pelletizer can be for pelletizing strands such as strands of plastic material into pellets, has a cutting mechanism which has a rotationally drivable cutting rotor and a counter-knife cooperating therewith, wherein a cutting gap is formed between a cutting edge of the counter-knife and rotor tooth tips of the cutting rotor, wherein a cutting gap adjustment apparatus with a cutting gap adjustment drive is provided for adjusting the gap dimension of the cutting gap during operation of the cutting mechanism.

It is therefore proposed to adjust or readjust the cutting gap during machine operation and to move the cutting rotor and/or the counter-knife transversely to the longitudinal axis of the cutting rotor for this purpose. According to the invention, a cutting gap adjustment apparatus with a cutting gap adjustment drive is provided for adjusting the gap dimension of the cutting gap during operation of the cutting mechanism. Such online adjustment of the cutting rotor or, if necessary, also of the counter-knife allows the system to react to changes in the gap dimension, for example during the start-up process, and the gap dimension can be optimally adjusted for operation of the cutting mechanism even under changing conditions.

Preferably, the cutting rotor is moved and the counter-knife is held fixably mounted. This allows a more stable design of the cutting mechanism and avoids unpleasant deformations of the counter-knife, which tends to be less rigid. At the same time, once the scraper gap to a feed roller of a feed device upstream of the cutting mechanism has been set, it can be kept constant and does not need to be readjusted when the cutting gap between the cutting rotor and counter-knife is adjusted or readjusted.

In a further development of the invention, the cutting gap adjustment apparatus can have a feed device for feeding the cutting rotor towards and away from the counter-knife, wherein a stationary fixation for the counter-knife can be provided, whereby the counter-knife can also be fixably mounted when the cutting rotor is adjusted.

The above-mentioned feed device can move the cutting rotor transversely to its rotor axis towards and away from the counter-knife in order to adjust the gap dimension of the cutting gap.

In a further development of the invention, the feed device can be configured to displace both end portions of the cutting rotor synchronously with one another, so that the cutting rotor is displaced exactly or exclusively translationally without a rotational component, in particular exactly perpendicular to its rotor axis. This increases or decreases the gap dimension evenly over the length of the cutting gap.

In an alternative further development of the invention, however, the feed device can also be configured to optionally displace the cutting rotor only translationally in the manner, i.e., synchronously with one another at both end portions, or to superimpose a rotational movement on the translational displacement, namely about an axis of rotation substantially perpendicular to the translational displacement movement and to the rotor axis, so that the two end portions of the cutting rotor are fed towards or moved away from the counter-knife to different degrees. This allows, for example, the cutting gap at the right end portion to be reduced or increased more than at the opposite left edge portion of the cutting rotor. Such an asymmetrical infeed makes it possible to react to any asymmetrical wear or asymmetrical temperature loads with corresponding thermal expansions, in particular to be able to set the cutting gap to the same size at the right and left edge section of the cutting rotor despite such asymmetrical effects.

In an advantageous further development of the invention, the adjustment drive of the cutting gap adjustment apparatus can have an electric stepper motor which permits exact adjustment of the cutting gap and can also be controlled simply and precisely.

In order to allow a fine conversion of the drive movement of the adjustment drive into the desired displacement of the cutting rotor or the respective cutting mechanism element, the cutting gap adjustment apparatus can have one or more worm gear stages, which in particular can convert a rotary movement of the adjustment drive into a translational displacement of the adjustment rotor with sufficient precision to be able to adjust the cutting gap precisely in the 1/100 mm range. In particular, such a worm gear stage can operate backlash-free.

In order to further refine the adjustment or to enable a very fine adjustment with simultaneously stable bearing of the cutting rotor, the cutting gap adjustment apparatus can comprise a cutting rotor bearing with eccentrically designed bearing shells. The cutting rotor bearing rotates the cutting rotor about its longitudinal axis or rotor axis, whereby the bearing shells are configured eccentrically and can be rotated about the rotor axis, so that a rotation of the bearing shells about the rotor axis causes a translational displacement of the rotor axis towards or away from the counter-knife.

Preferably, the cutting rotor is supported at its opposite end portions by two such cutting rotor bearings with eccentrically designed bearing shells in order to be able to provide a translational displacement at both rotor end portions by corresponding rotation of the eccentric bearing shells.

The adjustment drive can advantageously be configured to adjust the two eccentric bearing shells at opposite end portions of the cutting rotor synchronously with one another in order to achieve an equal increase or decrease in the gap dimension at both end portions.

In particular, the eccentric bearing shells of the cutting rotor bearing can be rotated via the worm gear stage, whereby the respective rotatable bearing shell can advantageously have an external toothing that meshes with the toothing of the actuator worm, so that a rotational movement of the worm shaft can cause the bearing shell to rotate about the rotor axis of the cutting rotor. The eccentricity converts the rotary movement of the bearing shell into a displacement of the cutting rotor.

In order to allow easy maintenance of the cutting mechanism, the eccentric bearing shells can be configured as half shells, which substantially only enclose the bearing shell interacting with them over an angular range of approximately 180° or fit snugly against it. This is sufficient for displacing the cutting rotor by rotating the eccentric bearing shell, while on the other hand it is possible to lift the cutting rotor out of the half shell or half bearing shell, which simplifies maintenance.

In particular, the half eccentric bearing shells can have a zero position in which the bearing shells are open towards the top, so that the cutting rotor can lie in the eccentric bearing shells, so to speak, and can be lifted out upwards.

The adjustment of the relative position of the cutting rotor and counter-knife in cutting unit operation can advantageously be semi-automatic or fully automatic. For example, a machine operator can be shown on a display device such as a display that an infeed of one or more steps would be useful in order to optimally adjust the cutting gap, so that the machine operator can then initiate a corresponding infeed under his control, for example by actuating an input device, for example in the form of a touchscreen button on a touchscreen display, on which the prompt can also be displayed. For example, such a semi-automatic control mode can be provided for the start-up process, for example to initiate a predetermined readjustment of the cutting gap towards the end of the start-up process or when stable operating conditions are reached.

In an advantageous further development of the invention, however, the cutting gap can also be set automatically without the intervention of the machine operator. In this respect there can be provided a sensor system for detecting at least one machine operating and/or pellet parameter relevant to the cutting gap as well as a control device for controlling the cutting gap adjustment drive depending on a signal from the sensor system.

The sensor system can advantageously detect the machine operating and/or pellet parameters during machine operation or while the cutting mechanism is running and provide a signal continuously or cyclically during machine operation that currently characterizes the machine operating and/or pellet parameters, so that the control device can adjust the cutting gap on the basis of the current sensor signal.

The control device can, in particular, control the aforementioned stepper motor if this is enabled by the machine operating and/or granulate parameters detected by sensors.

As machine operating parameters or pellet parameters, various variables can be monitored by sensors and used to set the cutting gap. For example, a sensor system can use one or more temperature sensors for sensory detection of one or more relevant machine or process temperatures, for example to detect water temperatures in the feed and/or return of the strand pelletizer and/or to detect a melt temperature of the material fed and/or a pellet temperature of the pellets, whereupon the control device can adjust the cutting gap depending on the temperature.

Alternatively, or additionally, the sensor system can, for example, also comprise one or more vibration sensors for detecting vibrations on granulator components such as the cutting mechanism, in order to initiate an adjustment depending on a sensor signal that can characterize the strength of the vibrations.

In particular, however, the sensor system can detect the cutting gap itself with regard to the current gap dimension and provide a signal that indicates the gap dimension and/or characterizes changes in the gap dimension.

In particular, in a further development of the invention, the cutting gap between the cutting rotor and the counter-knife can be measured as an operating parameter of the strand pelletizer during operation, i.e., when the cutting rotor is running and/or when the strands are being cut, and a sensor system suitable for this purpose can be used. Advantageously, at least one sensor for determining the cutting gap during operation of the cutting mechanism is provided on the stationary counter-knife. The at least one sensor operating in cutting mode can be used to detect or monitor changes in the cutting gap during operation and, in particular, dynamic changes in the cutting gap during the start-up process. Knowledge of the dynamic behavior of the cutting gap makes it possible to set the gap dimension to an optimum value that ensures a high-quality cut on the one hand and avoids the risk of the cutting rotor running up against the counter-knife on the other.

In a further development of the invention, the at least one sensor is positioned in the immediate vicinity or immediate neighborhood of the cutting edge of the counter-knife in order to be able to detect cutting gap changes as directly as possible.

In particular, the at least one sensor can be rigidly attached to the counter-knife so that the sensor follows or experiences changes in the distance between the counter-knife and the strand rotor in the same way as the counter-knife.

In particular, the at least one sensor can be arranged at least partially recessed in the counter-knife and, in relation to the direction of rotation of the cutting rotor, can be arranged behind or downstream of the cutting edge of the counter-knife and thereby look onto the rotor teeth passing the counter-knife. Preferably, the at least one sensor can be located directly under the cutting edge of the counter-knife, where “under” means that the cutting edge itself protrudes slightly, for example in the manner of a roof protrusion, over the sensor towards the cutting rotor and a passing rotor tooth first brushes past the cutting edge itself and then past the sensor.

The sensor can be arranged on the counter-knife, for example, in such a way that the sensor is directly opposite a rotor tooth of the cutting rotor when the rotor tooth has traveled an angle of rotation of less than 20° or less than 10° or less than 5°, relative to the cutting rotor position in which the rotor tooth is exactly at the cutting edge of the counter-knife with its rotor tooth tip.

The at least one sensor can advantageously be configured to detect the passing rotor tooth tips of the cutting rotor, in particular the distance from the rotor tooth tips.

The at least one sensor mentioned is advantageously a non-contact distance sensor. In particular, the sensor can be configured in the form of an eddy current sensor.

Such an eddy current sensor makes it possible to determine the distance to the conductive rotor tooth tips, which can be configured from steel or another conductive alloy, for example. Advantageously, non-conductive media such as water or coolant and the material of the strands of plastic material, for example, have no influence on the measurement result with such an eddy current sensor.

In order to be able to detect the rotor tooth tips, which usually pass by very quickly, with sufficient accuracy, the at least one sensor can be operated with a relatively high sampling frequency, which in a further development of the invention can be more than 2 kHz or more than 5 kHz or more than 10 kHz, or even more than 20 kHz or more than 50 kHz or even more than 100 kHz.

In an advantageous further development of the invention, several sensor are arranged distributed along the cutting gap in order to be able to measure the cutting gap in different portions of the cutting mechanism. This means that uneven dynamic changes in the cutting gap across the width can also be precisely detected, for example if the central portion is fed more heavily there than at the edges to the right and left of the cutting mechanism.

These and other objects, features and advantages of the present invention will become more apparent upon reading the following specification in conjunction with the accompanying drawing figures.

### BRIEF DESCRIPTION OF THE DRAWINGS

The accompanying Figures, which are incorporated in and constitute a part of this specification, illustrate several aspects described below.

FIG. 1 is a perspective, partially free-cut side view of a strand pelletizer according to an advantageous embodiment of the invention, wherein the cutting mechanism of the strand pelletizer comprising a cutting rotor and a counter-knife as well as a feed device upstream of the cutting mechanism comprising a pair of feed rollers rotating in opposite directions can be seen.

FIG. 2 is a sectional view of the cutting mechanism and the upstream feed rollers, showing a distance sensor provided under the cutting edge of the counter-knife for detecting the cutting gap dimension.

FIG. 3 is a sectional, enlarged cross-sectional view through the sensor of FIG. 2, which is recessed in the counter-knife and shows its position in the counter-knife and relative to the rotor tooth tips of the cutting rotor.

FIGS. 4A-4C are perspective views of a cutting rotor bearing with eccentric bearing shells, which can be adjusted by an adjustment drive via a worm gear stage in order to move the cutting rotor towards or away from the counter-knife.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

As the figures show, the strand pelletizer 1 comprises a cutting mechanism 2 which has a rotationally drivable cutting rotor 3 with which a counter-knife 4 is associated, so that strands entering the cutting mechanism 2, such as thermoplastic strands of plastic material, can be cut or sheared off by the cutting rotor 2 at the counter-knife 4.

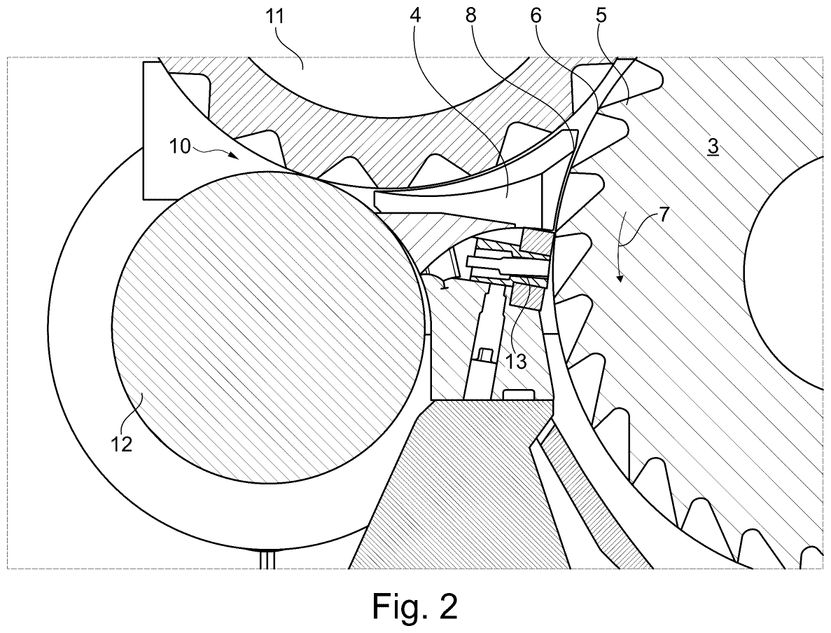

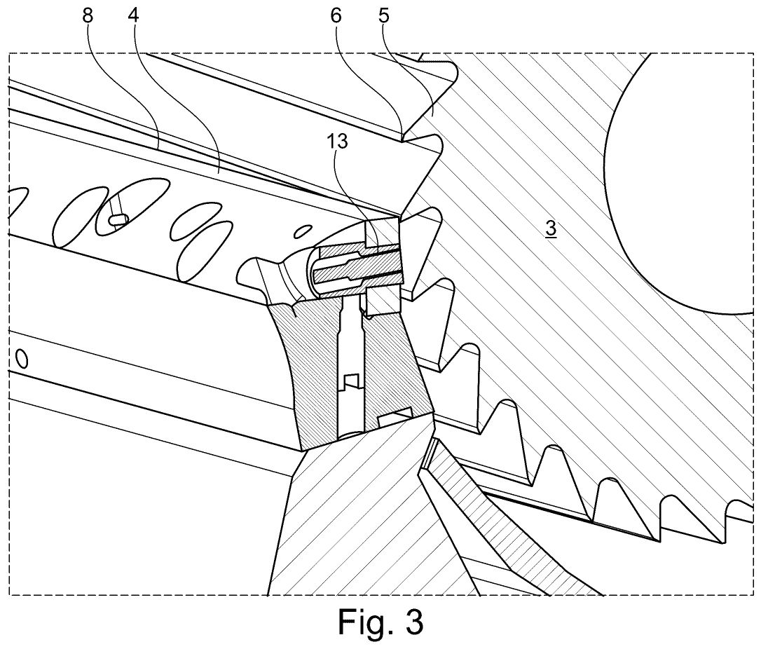

In a manner known per se, the cutting rotor 3 has peripheral cutting projections or rotor teeth 5, which can be configured in the form of strips and extend substantially over the entire length of the cutting rotor 3. The cutting projections or rotor teeth 5 may be arranged substantially parallel to the longitudinal axis of the roller of the cutting rotor 3, but may also extend at an angle thereto or extend slightly helically along the cylindrical enveloping surface of the cutting rotor 3. Viewed in cross-section, the rotor teeth can be configured to be acute overall and/or inclined with respect to the radial direction, so that the tooth tips look slightly forward at an angle with respect to the direction of rotation 7 of the cutting rotor 3 in order to be able to “bite” into the strands, cf. FIG. 2 and FIG. 3.

The counter-knife is arranged on the enveloping surface of the cutting rotor 3 and can be configured in the shape of a strip or form a web-shaped blade, against which the cutting knife 2 passes with its rotor teeth 5. In particular, the counter-knife 3 can have a cutting edge 8 that extends along the enveloping surface of the cutting rotor 3, in particular parallel to the axis of rotation of the cutting rotor 3, and can be undercut or “sharpened” at a slightly acute edge angle, cf. FIG. 2.

A cutting gap is defined between the cutting edge 8 of the counter-knife 4 and the tooth tips 6 of the rotor teeth 5 of the cutting rotor 3, the gap dimension of which can be in the range of a few hundredths of a mm.

In order to feed the strands to be cut, such as thermoplastic strands of plastic material or food strands, to the cutting mechanism 2 at a controlled speed and in a controlled direction, a feed device 10 is connected upstream of the cutting mechanism 2, which comprises two feed rollers 11, 12 rotating in opposite directions to convey the strands between them and towards the cutting mechanism 2. As FIG. 2 shows, the counter-knife 4 is located in the delivery area of the feed rollers 11, 12 and is arranged between the feed rollers 11, 12 and the cutting rotor 3.

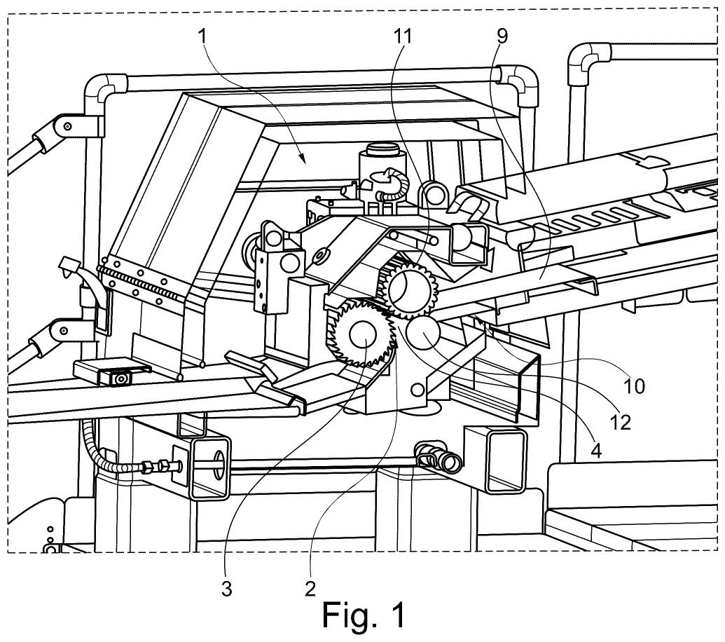

The strands to be pelletized, which can come from a continuous caster, can reach the feed device 2 by means of a conveying device such as a drainage trough 9, cf. FIG. 1, as is known per se.

In order to be able to determine the gap dimension of the cutting gap between the cutting edge 8 of the counter-knife 4 and the tooth tips 6 of the cutting rotor 3 even during operation of the cutting mechanism 2, a sensor is assigned to the cutting mechanism 2, which has at least one sensor 13, which is provided on the stationary counter-knife 4, cf. FIG. 2 and FIG. 3. Advantageously, several sensors 13 can be arranged distributed over the length of the cutting gap in order to be able to determine the gap dimension in different portions of the cutting mechanism 2.

As FIGS. 2 and 3 show, the sensor 13 is advantageously mounted on the counter-knife 4 in the immediate vicinity of the cutting edge 8, so that the sensor 13 follows changes in the distance of the counter-knife 4 from the cutting rotor 3. In particular, in relation to the direction of rotation 7 of the cutting rotor 3, the at least one sensor 13 is positioned directly behind or downstream of the cutting edge 8 on a portion of the counter-knife 4 that a respective rotor tooth 5 reaches after it has passed the cutting edge 8.

As FIGS. 2 and 3 show, the sensor 13 can advantageously be arranged at least partially recessed in the counter-knife 3, whereby the counter-knife 4 can, for example, have a bore open towards the cutting rotor 3, for example in the form of a blind hole, in which the sensor can be arranged recessed. If the sensor is fitted with a data cable, a through-hole or cross-hole can also be provided in the counter-knife to lead the cable out. However, the sensor can also have a wireless data transmission module, for example with a Bluetooth or radio interface.

The sensor 13 can look with its sensor head onto the rotor teeth 5 running past, whereby the sensor head can be arranged exposed or flush with the counter blade flank facing the cutting rotor 3, cf. FIGS. 2 and 3.

The sensor 13 is advantageously configured as a non-contact distance sensor, in particular in the form of an eddy current sensor, which can detect the distance of the sensor head and thus of the counter-knife 4 from the tooth tips 6 of the rotor teeth 5 passing by. The sensor head of the sensor 13 generates an eddy current field directed towards the rotor teeth 5, which is affected by the ferromagnetic rotor teeth depending on their distance from the sensor head, so that the sensor 13 can provide a sensor signal characterizing the distance.

Advantageously, the sensor 13 operates with a sufficiently high sampling frequency of more than 2 kHz or more than 5 kHz or more than 10 kHz, for example, in order to be able to precisely detect the very fast passing tooth tips 6.

Advantageously, the gap dimension of the cutting gap measured online can be used to set the gap dimension appropriately by adjusting the position of the cutting rotor 3 and/or counter-knife 4, which can advantageously also be carried out during operation of the cutting mechanism, but possibly also in the stopped state, wherein a feed device with an adjustment drive can be controlled by a control device depending on the signal of the sensor 13 in order to move the cutting rotor 3 closer to or further away from the counter-knife 4, wherein the counter-knife 4 can also be moved accordingly if necessary.

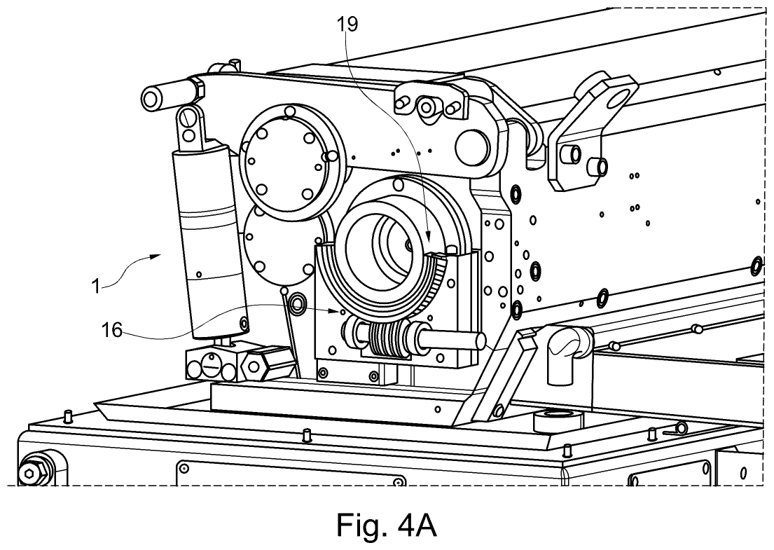

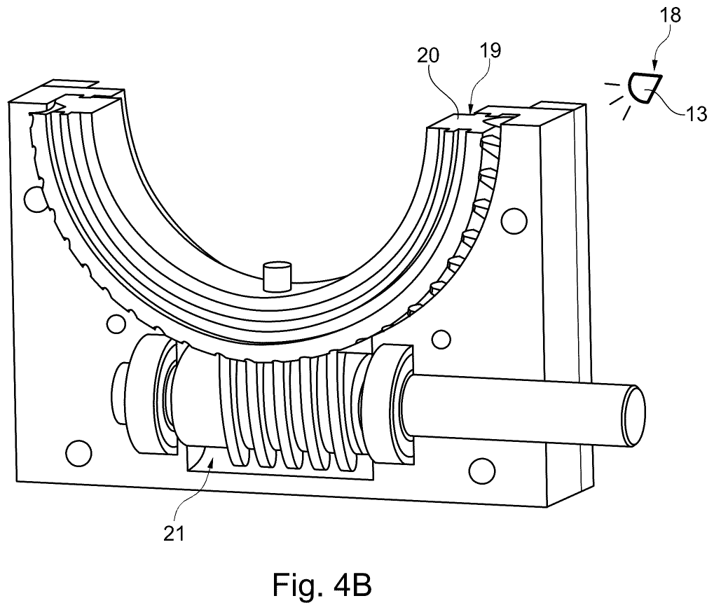

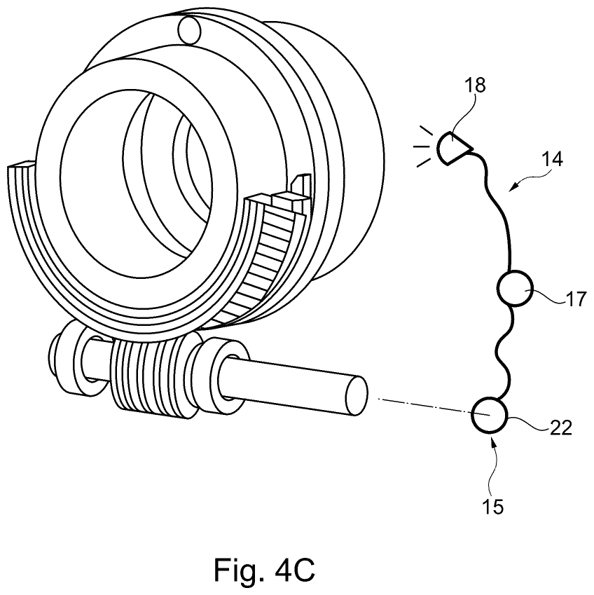

As FIGS. 4A-4C show, the cutting rotor 3 can be rotatably mounted on a cutting mechanism or a machine frame at its opposite end portions by means of two cutting rotor bearings 19, whereby FIG. 4A shows only one of these cutting rotor bearings 19 at one end portion of the cutting rotor 3.

As FIGS. 4A-4C illustrate, the cutting rotor bearings 19 comprise eccentrically designed bearing shells 20, which are configured eccentrically with respect to the rotor axis of the cutting rotor and can be rotated about an axis of rotation parallel to the rotor axis of rotation, so that a translational displacement of the cutting rotor 3 towards or away from the counter-knife 4 occurs due to the eccentric contouring of the bearing shells 20. More precisely, each cutting rotor bearing 19 moves “its” end portion of the cutting rotor 3 towards or away from the counter-knife 4 when its eccentric bearing shell 20 is rotated.

The eccentric bearing shells 20 can be rotatably mounted on the cutting unit frame or the machine frame.

As FIGS. 4A-4C further show, the eccentric bearing shells 20 can advantageously be rotated via a worm gear stage 21, whereby such a worm gear stage 21 can be provided for each of the cutting rotor bearings 19.

The worm gear stage 21 can advantageously have an external toothing on the rotatable bearing shell 20, which meshes with a worm drive shaft, so that a rotation of the worm drive shaft causes a corresponding rotation of the bearing shell 20, cf. FIG. 4B and FIG. 4C. Preferably, the worm gear shaft can extend parallel to a wall and/or an outer side of the cutting mechanism frame that supports the cutting mechanism 2 and/or transversely to the cutting rotor bearing, cf. FIG. 4B.

The worm gear stages 21 at the opposite end portions of the cutting rotor 3 can be driven by stepper motors 22, which can rotationally drive the worm gear shafts, possibly via an intermediate gear stage.

The stepper motors 22 are controlled by a control device 21, which can be configured as an electronic control device, for example in the form of a control computer, which can process a control program stored in a memory or also several control programs by means of a processor in order to set the gap dimension of the cutting gap depending on a relevant machine operation and/or pellet parameter or to adjust it during operation.

As FIG. 4C illustrates, the control device 17 is connected to a sensor system 18, which may comprise the described cutting gap sensor 13 and/or also other sensors, in order to move the cutting rotor 3 towards or away from the counter-knife 4 depending on a sensor signal characterizing the respective machine operating parameter and/or pellet parameter.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A cutting mechanism comprising:
a rotationally drivable cutting rotor with rotor tooth tips;
a counter-knife with a cutting edge; and
a cutting gap adjustment apparatus;
wherein:
strands entering the cutting mechanism can be sheared off by the rotationally drivable cutting rotor at the counter-knife;
a cutting gap is formed between the cutting edge of the counter-knife and the rotor tooth tips of the cutting rotor; and
the cutting gap adjustment apparatus is configured to adjust the dimension of the cutting gap during operation of the cutting mechanism.

2. The cutting mechanism of claim 1, wherein:
the cutting gap adjustment apparatus comprises:
a cutting gap adjustment drive;
a sensor system; and
a control device;
the sensor system is configured to detect one or more machine operating and/or pellet parameters during operation of the cutting mechanism; and
the control device is configured to control the cutting gap adjustment drive depending on one or more of the machine operating and/or pellet parameters detected by sensor system.

3. The cutting mechanism of claim 1, wherein the cutting gap adjustment apparatus comprises a feed device for adjusting the rotationally drivable cutting rotor towards and away from the counter-knife.

4. The cutting mechanism of claim 2, wherein the control device of the cutting gap adjustment apparatus is further configured to automatically actuate the cutting gap adjustment drive during operation of the cutting mechanism without the intervention of a machine operator.

5. The cutting mechanism of claim 3, wherein the counter-knife is fixably mounted.

6. A strand pelletizer comprising the cutting mechanism of claim 2.

7. The strand pelletizer of claim 6, wherein:
the control device of the cutting gap adjustment apparatus is further configured to automatically actuate the cutting gap adjustment drive during operation of the cutting mechanism without the intervention of a machine operator;
the cutting gap adjustment apparatus further comprises a feed device for adjusting the rotationally drivable cutting rotor towards and away from the counter-knife; and
the counter-knife is fixably mounted.

8. The strand pelletizer of claim 6, wherein the sensor system comprises a gap sensor for determining the gap dimension of the cutting gap during operation of the cutting mechanism.

9. The strand pelletizer of claim 6, wherein the sensor system comprises sensors distributed over the length of the cutting gap and mounted on the counter-knife.

10. The strand pelletizer of claim 6, wherein the cutting gap adjustment apparatus further comprises a worm gear stage for displacing the rotationally drivable cutting rotor towards and away from the counter-knife.

11. The strand pelletizer of claim 6, wherein the cutting gap adjustment drive comprises an electric stepper motor.

12. The strand pelletizer of claim 6, wherein the cutting gap adjustment drive comprises a plurality of stepper motors provided for adjusting the cutting gap at different portions along rotationally drivable cutting rotor.

13. The strand pelletizer of claim 6 further comprising a synchronizing device for synchronizing the adjustment of the rotationally drivable cutting rotor at different rotationally drivable cutting rotor portions;
wherein the synchronizing device is configured electronically and/or provided with an electronic synchronizing control module for synchronously controlling a plurality of stepper motors.

14. The strand pelletizer of claim 6, wherein the control device comprises a controller for actuating the cutting gap adjustment drive depending on the dimension of the cutting gap determined by the sensor system and adjusting dimension of the cutting gap to a target value.

15. The strand pelletizer of claim 6, wherein the sensor system comprises a sensor directed towards the passing rotor tooth tips of the rotationally drivable cutting rotor and/or detects a spacing of the passing rotor tooth tips from a sensor head of the sensor and/or the counter-knife.

16. The strand pelletizer of claim 6, wherein the sensor system comprises a sensor arranged at least partially recessed in the counter-knife and is arranged behind the cutting edge of the counter-knife with respect to a direction of rotation of the rotationally drivable cutting rotor and faces the rotationally drivable cutting rotor.

17. The strand pelletizer of claim 6, wherein the sensor system comprises a sensor arranged at a flank portion of the counter-knife that is reached by a rotor tooth with an angle of rotation of less than 20° with respect to the rotationally drivable cutting rotor position in which the rotor tooth lies with its rotor tooth tip exactly at the cutting edge of the counter-knife.

18. The strand pelletizer of claim 6, wherein the sensor system comprises a sensor arranged at a flank portion of the counter-knife that is reached by a rotor tooth with an angle of rotation of less than 5° with respect to the rotationally drivable cutting rotor position in which the rotor tooth lies with its rotor tooth tip exactly at the cutting edge of the counter-knife.

19. The strand pelletizer of claim 6, wherein the sensor system comprises a sensor having a sampling frequency of more than 2 kHz.

20. The strand pelletizer of claim 6, wherein the sensor system comprises a sensor having a sampling frequency of more than 30 kHz.

21. The strand pelletizer of claim 6, wherein the sensor system comprises a controller connected to a sensor and processing the signals thereof.

22. The strand pelletizer of claim 7, wherein the feed device comprises a cutting rotor bearing that rotatably supports the rotationally drivable cutting rotor and is configured to be adjustable transversely to the longitudinal axis of the rotationally drivable cutting rotor.

23. The strand pelletizer of claim 7, wherein:
the feed device comprises at least two cutting rotor bearings that rotatably support the rotationally drivable cutting rotor and are configured to be adjustable transversely to the longitudinal axis of the rotationally drivable cutting rotor; and
two of the cutting rotor bearings are provided at opposite end portions of the rotationally drivable cutting rotor.

24. The strand pelletizer of claim 8, wherein the gap sensor is provided on the counter-knife.

25. The strand pelletizer of claim 8, wherein the gap sensor is arranged in the immediate vicinity of the cutting edge of the counter-knife.

26. The strand pelletizer of claim 8, wherein the gap sensor is configured as a non-contact measuring distance sensor.

27. The strand pelletizer of claim 8, wherein the gap sensor is configured as an eddy current sensor.

28. The strand pelletizer of claim 9, wherein the cutting gap adjustment apparatus is configured to displace the rotationally drivable cutting rotor at different rotationally drivable cutting rotor portions individually depending on sensor signals of at least a portion of the sensors.

29. The strand pelletizer of claim 9, wherein the cutting gap adjustment apparatus is configured to displace the rotationally drivable cutting rotor portions individually to different degrees depending on sensor signals of at least a portion of the sensors.

30. The strand pelletizer of claim 23, wherein the cutting rotor bearing has an eccentrically configured bearing shell that can be rotated about an axis of rotation parallel to the longitudinal axis of the rotationally drivable cutting rotor and, when rotated, displaces the rotationally drivable cutting rotor towards or away from the counter-knife as a result of the eccentricity.

31. The strand pelletizer of claim 30, wherein the eccentrically configured bearing shell is configured as a half-shell and to be open to one side for removing the rotationally drivable cutting rotor.
